(19) United States
(12) Patent Application Publication
(10) Pub. No.: US 2014/0156184 A1
(43) Pub. Date: Jun. 5, 2014

(54) NAVIGATION MESSAGE PROVIDING SYSTEM AND METHOD THEREOF

(71) Applicants: INVENTEC (PUDONG) TECHNOLOGY CORPORATION, Shanghai (CN); INVENTEC CORPORATION, Taipei (TW)

(72) Inventor: Chaucer CHIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/832,009

(22) Filed: Mar. 15, 2013

(30) Foreign Application Priority Data
Nov. 30, 2012 (CN) 201210507454.9

(51) Int. Cl. G01C 21/00

(52) U.S. Cl. CPC G01C 21/00
USPC 701/519; 701/537

(57) ABSTRACT

A navigation message providing system and a method thereof are provided. A server searches, according to a planned moving path, for a location message corresponding to a target location, and when determining that a distance or a relative position of a position where the navigation terminal is currently located and the target location satisfies a predetermined condition or determining that preset time or a preset position is met, a navigation terminal displays the satisfied or met location message, so as to give a prompt to a user when close to the target location, and achieve the technical efficacy of proactively providing location message of the target location.

### BACKGROUND OF THE INVENTION

1. Field of the Invention

The present invention relates to a message display system and a method thereof, and more particularly to a navigation message providing system and a method thereof.

2. Description of Related Art

Most of current electronic maps have a path planning function. A user only needs to input names or coordinates of a starting position and a target position in an input field provided by an electronic map, or directly clicks a starting position and a target position on an electronic map, so that the electronic map may plan a suggested moving path according to the starting position and the target position. Furthermore, an electronic map executed in a navigation device may further directly plan a moving path according to a current position obtained through detection as a starting position, and give a corresponding voice message at appropriate time, so as to guide a user to leave for a target position.

To provide detailed map information of a user, a large amount of content is always included in an electronic map, for example, content included in a paper map, such as a road map, a road name and a landmark, and points of interest (POI) such as a gas station, a convenience shop, a restaurant, a building, and a scenic spot are included.

However, a current electronic map generally does not particularly mark POIs such as a landmark and a scenic spot on a planned moving path, and also does not provide relevant information of the POIs on the moving path after planning and displaying the moving path, so that a user must browse the map to view a landmark and a scenic spot on the moving path, and additionally search for relevant information of the landmark and the scenic spot. Additionally, an electronic map executed in a navigation device also does not prompt a user when the navigation device is close to a landmark or a scenic spot, and certainly does not provide relevant information of the landmark and the scenic spot, which is inconvenient for a user during a tour.

To sum up, it can be known that, in the prior art, a problem that an electronic map fails to give a prompt to a user when close to a target location always exists for a long time; therefore, it is actually necessary to propose improved technical means to solve this problem.

### SUMMARY OF THE INVENTION

In view of the problem that an electronic map fails to give a prompt to a user when close to a target location existing in the prior art, the present invention discloses a navigation message providing system and a method thereof.

A navigation message providing system disclosed in the present invention is applied to a navigation terminal and at least includes: a parameter setting module, used for setting a path planning parameter, where the path planning parameter at least includes a starting position and a target location and is used for planning and generating a moving path; a transmission module, used for receiving a location message corresponding to the target location which is found according to the moving path; and a display module, used for displaying the moving path, and used for display the met location message when preset time or a preset position in the location message is met, or displaying the location message corresponding to the target location that satisfies a predetermined condition when a driving distance or a relative position of a position where the navigation terminal is currently located and the target location satisfies the predetermined condition.

A navigation message providing method disclosed in the present invention at least includes the following steps: a navigation terminal setting a path planning parameter, where the path planning parameter at least includes a starting position and a target location; the navigation terminal transferring the path planning parameter to a server; the server planning a moving path according to the path planning parameter; the server searching, according to the moving path, for a location message corresponding to the target location; the navigation terminal displaying the moving path; and the navigation terminal, when determining that a driving distance or a relative position of a position where the navigation terminal is currently located and the target location satisfies a predetermined condition, displaying the location message corresponding to the target location that satisfies the predetermined condition.

Another navigation message providing method disclosed in the present invention at least includes the following steps: a navigation terminal setting a path planning parameter, where the path planning parameter at least includes a starting position and a target location; the navigation terminal transferring the path planning parameter to a server; the server planning a moving path according to the path planning parameter; the server searching, according to the moving path, for a location message corresponding to a target location; the server determining preset time or a preset position of the location message according to the path planning parameter; the navigation terminal displaying the moving path; the navigation terminal determining, according to the preset time or the preset position, whether the location message is met; and the navigation terminal displaying the met location message.

The system and method disclosed in the present invention are described as above, and the difference from the prior art lies in that in the present invention, the server searches, according to the planned moving path, for the location message corresponding to the target location, the navigation terminal, when determining that the driving distance or the relative position of the position where the navigation terminal is currently located and the target location satisfies the predetermined condition or determining that the preset time or the preset position is met, displays the satisfied or met location message so as to solve the problem existing in the prior art and achieve the technical efficacy of proactively providing location message for a user.

### BRIEF DESCRIPTION OF THE DRAWINGS

The invention will become more fully understood from the detailed description given herein below illustration only, and thus is not limitative of the present invention, and wherein:

FIG. 1 is a schematic diagram of an operating environment according to an embodiment of the present invention.

FIG. 2 is an architecture diagram of a navigation message providing system according to the present invention.

FIG. 3A is flowchart of a navigation message providing method according to the present invention.

FIG. 3B is a flowchart of another navigation message providing method according to the present invention.

FIG. 3C is a flowchart of another navigation message providing method according to the present invention.

FIG. 4A is a schematic diagram of a moving path according to an embodiment of the present invention.

FIG. 4B is a schematic diagram of reaching of a target location according to an embodiment of the present invention.

FIG. 4C is a schematic diagram of a driving distance to a target location on a moving path satisfying a preset value according to an embodiment of the present invention.

### DESCRIPTION OF THE EMBODIMENTS

The present invention will be apparent from the following detailed description, which proceeds with reference to the accompanying drawings, wherein the same references relate to the same elements.

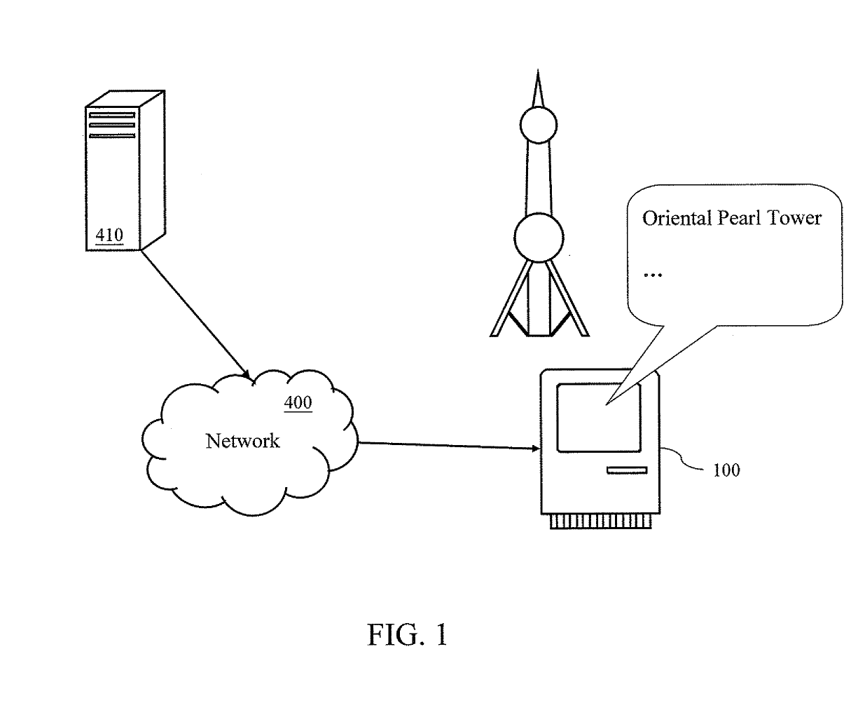

In the present invention, as shown in FIG. 1, after a navigation terminal 100 displays a moving path planned for a user, the navigation terminal 100 may download, through a network 400, a location message of a target location surrounding the moving path from a server 410, and display the downloaded location message at appropriate time. The navigation terminal 100 mentioned in the present invention is a device including an input function, a display function, and a wireless transmission function, such as, a mobile phone, a personal digital assistant (PDA), a tablet computer, and a notebook.

The target location mentioned in the present invention may be, for example, a scenic spot, an office building, a shopping mall, a government agency, and an exhibit stadium, and so on; however, the present invention is not limited thereto, and any location where data that can be or needs to be illustrated/introduced for others exists can be the target location mentioned in the present invention.

The location message mentioned in the present invention corresponds to the target location, and each location message corresponds to one target location. The location message may be, for example, an advertisement relevant to the corresponding target location or natural and human information or tourism information of the corresponding target location, and so on; however, the present invention is also not limited thereto, and any data that can be or needs to be illustrated/introduced for others can be the location message provided in the present invention.

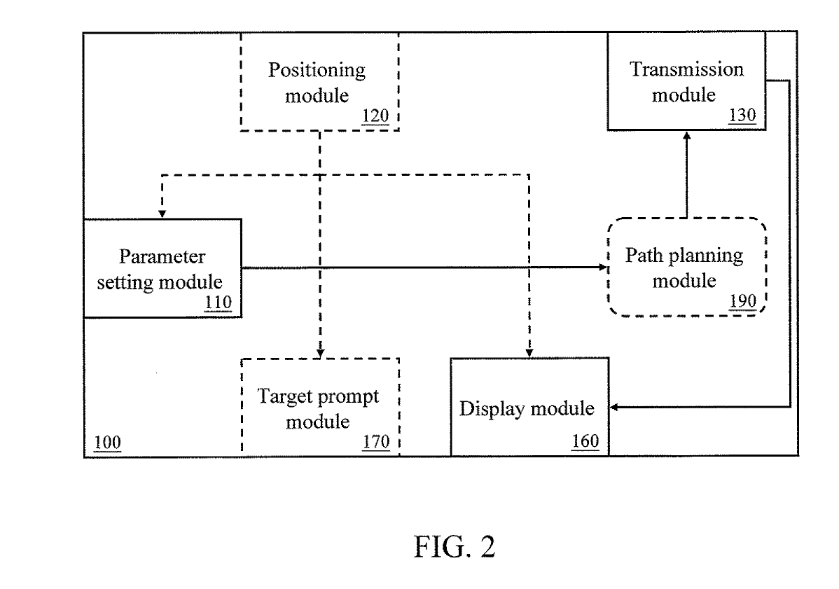

System operating of the present invention is first illustrated below through an architecture diagram of a navigation message providing system according to the present invention in FIG. 2. As shown in FIG. 2, the system of the present invention is applied to a navigation terminal 100, which includes a parameter setting module 110, a transmission module 130, and a display module 160.

The parameter setting module 110 is responsible for setting a path planning parameter. The parameter setting module 110 may provide one or more operation manners such as receiving a voice signal, receiving a touch signal, and/or receiving a key signal, so as to set the path planning parameter.

The path planning parameter set by the parameter setting module 110 may be used for planning and generating one or more moving paths, and the path planning parameter includes a specific location, a planning condition, and so on, where the specific location may be, for example, a starting position of a user, a target position of the user, a stay position of the user, and so on, and the planning condition may be, for example, keeping away from a specific location or a road section, a preferred road type, and so on; however, the path planning parameter provided in the present invention is not limited thereto, and any project capable of influencing moving path planning can be the path planning parameter provided in the present invention. It should be particularly noted that, the path planning parameter at least includes the target position of the user.

The transmission module 130 may transfer, through a network 400, the path planning parameter set by the parameter setting module 110, and receive a moving path planned according to the path planning parameter, which is returned by the server 410 through the network 400, and a location message corresponding to a target location surrounding the moving path. The server 410 may find one or more target locations, and each target location may correspond to one or more location messages.

It should be particularly noted that, the transmission module 130 does not necessarily transfer the path planning parameter to the server 410, and also does not necessarily receive the moving path returned by the server 410. In a part of embodiments, the transmission module 130 may transfer, through the network 400, a moving path planned by a path planning module 190 to the server 410, so that the server 410, after searching for a target location according to the moving path transferred by the transmission module 130, and reading a location message of the found target location, returns the read location message to the transmission module 130. The path planning module 190 is illustrated later.

The display module 160 is responsible for displaying the moving path received by the transmission module 130 or the moving path planned by the path planning module 190, and additionally, the display module 160 is also responsible for displaying the location message received by the transmission module 130 at an appropriate time point, so as to determine a display frequency and display time of each location message.

The display module 160 may start timing after the transmission module 130 transfers the path planning parameter/moving path to the server 410 or after the transmission module 130 receives the location message transferred by the server 410, and display the location message that meets preset time when the time calculated by the display module 160 meets the preset time in the location message received by the transmission module 130. The display module 160 may also display the location message that meets preset time when system time (current time) of the navigation terminal 100 meets the preset time in the location message.

The display module 160 may also adjust display time and a display frequency of each location message according to a time difference between the system time of the navigation terminal 100 and the preset time in the location message. For example, if the transmission module 130 receives three location messages, and when the system time is earlier than preset time in the three location messages, the display module 160 may increase a display frequency and display time of a location message of which the preset time is the earliest, and lower a display frequency and display time of a location message of which the preset time is the latest. For another example, when the system time is between the earliest preset time and the second earlier preset time, the display module 160 may increase a display frequency and display time of a location message of which the preset time is the second earlier, and lower the display frequency and the display time of the location message of which the preset time is the earliest.

In practice, a manner for the display module 160 to determine the appropriate time for displaying the location message is not limited thereto, and the display module 160 may further determine whether a position where the navigation terminal 100 is located, which is determined by a positioning module 120, meets the preset position in the location message received by the transmission module 130, and when the position where the navigation terminal 100 is currently located meets the preset position in the location message, the display module 160 may display the location message in which the preset position is met.

The display module 160 may also adjust the display time and the display frequency of each location message according to a driving distance or a relative position of a position where the navigation terminal 100 is located and the preset position in the location message. For example, if the transmission module 130 receives three location messages, and when the navigation terminal 100 is close to a first reached preset position in the three location message, the display module 160 may increase a display frequency and display time of a location message in which a preset position can be first reached, and lower a display frequency and display time of a location message in which a preset position that can be finally reached. For another example, when the navigation terminal 100 moves between the preset position that can be first reached and a centred preset position, the display module 160 may increase a display frequency and display time of a location message in which a preset position is centred, and lower the display frequency and the display time of the location message in which the preset position is first reached.

The display module 160 may further display the location message corresponding to the target location that satisfies the predetermined condition when determining that the driving distance or the relative position of the position where the navigation terminal 100 is currently located and the target location received by the transmission module 130 satisfies the predetermined condition. The foregoing predetermined condition may be, for example, a target location of which a driving distance to the position where the navigation terminal 100 is currently located is within a preset value, or a target location that the navigation terminal 100 does not reach and of which a driving distance to the position where the navigation terminal 100 is currently located is the shortest, and so on. However, the present invention is not limited thereto, and any manner that enables a user to effectively obtain a location message corresponding to a surrounding target location can be used in the present invention.

Similarly, the display module 160 may still adjust the display time and the display frequency of each location message according to a driving distance between a position where the navigation terminal 100 is located and each target location on the moving path.

Additionally, in the present invention, the positioning module 120, a target prompt module 170 and/or the path planning module 190 can be added.

The positioning module 120 is responsible for obtaining position information of the navigation terminal 100 through an external positioning system of the present invention, and determining, according to the obtained position information, the position where the navigation terminal 100 is currently located. The foregoing positioning system includes but is not limited to a Global positioning system (GPS), a telephone signal positioning system, and so on.

In a part of embodiments, the parameter setting module 110 may directly take the position where the navigation terminal 100 is currently located, which is determined by the positioning module 120, as the starting position of the user; however, the present invention is not limited thereto.

The target prompt module 170 is responsible for determining a driving distance between the position where the navigation terminal 100 is currently located and a target location corresponding to each piece of location message on the moving path and outputting a prompt message corresponding to a target location when a driving distance between the position where the navigation terminal 100 is currently located and a certain target location is smaller than a preset value.

The prompt message output by the target prompt module 170 may be a text and/or an image displayed on the navigation terminal 100, and may also be a control signal that enables the navigation terminal 100 to make a sound or vibrate, and so on, which is not particularly limited in the present invention, and any manner capable of having an effect of drawing attention of a user can be the prompt message provided in the present invention.

The path planning module 190 is responsible for planning and generating the moving path according to the path planning parameter set by the parameter setting module 110.

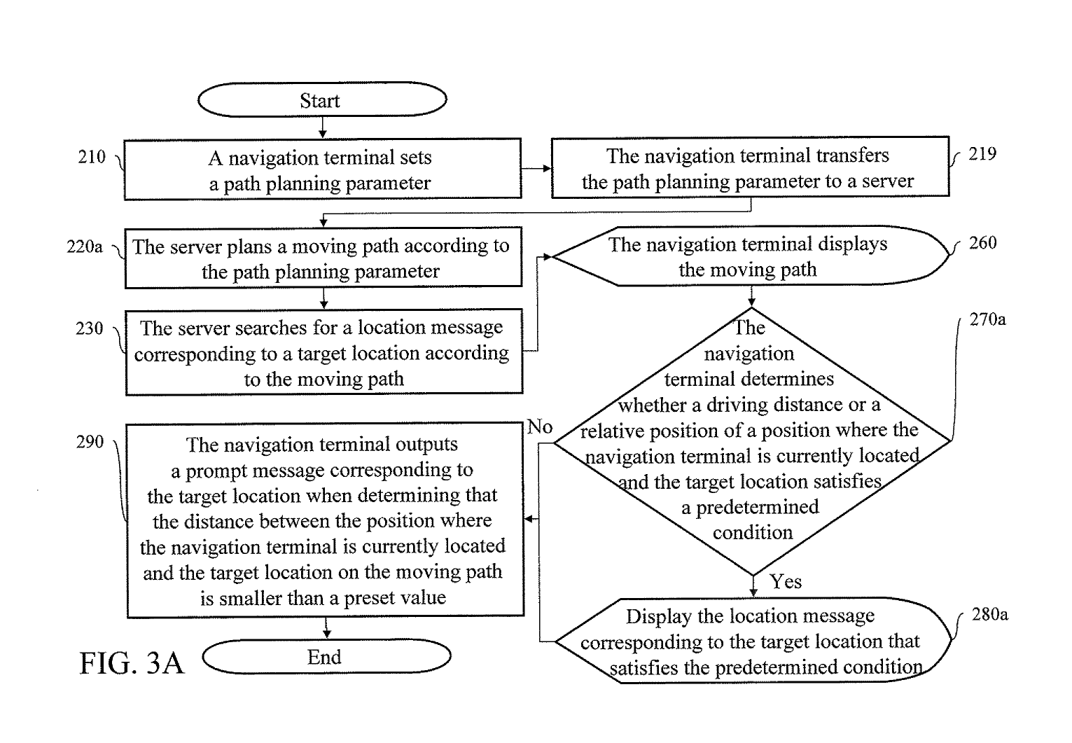

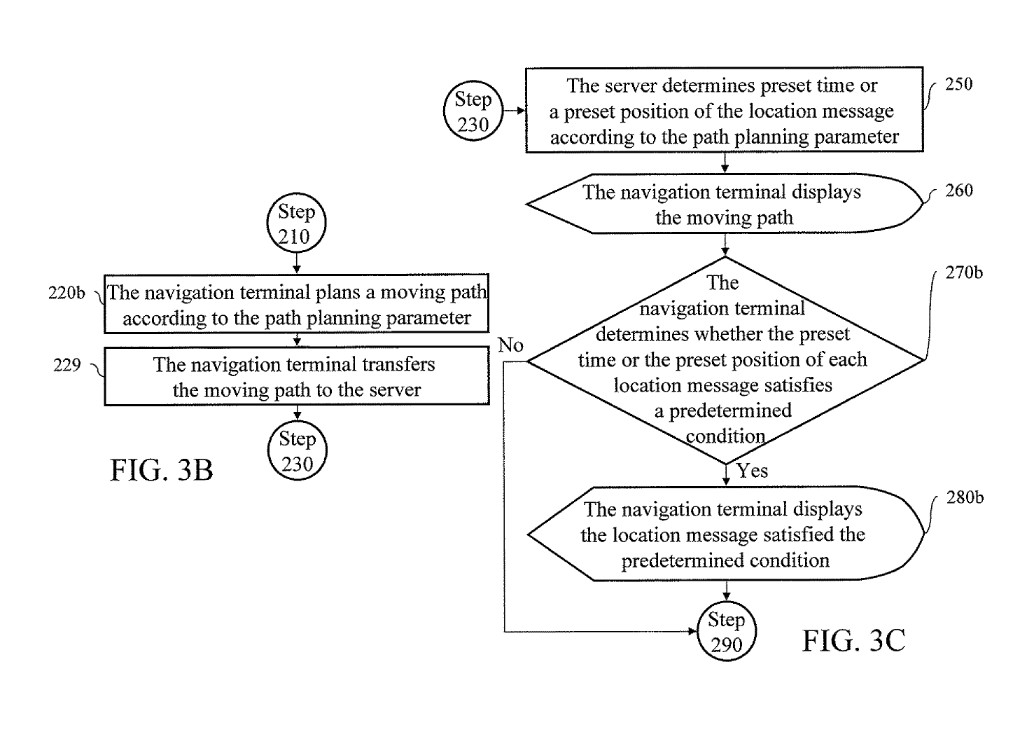

Then, the operating system and method of the present invention is illustrated through a first embodiment with reference to a flowchart of a navigation message providing method according to the present invention in FIG. 3A. In this embodiment, it is assumed that a navigation terminal 100 is a smart mobile phone; however, the present invention is not limited thereto.

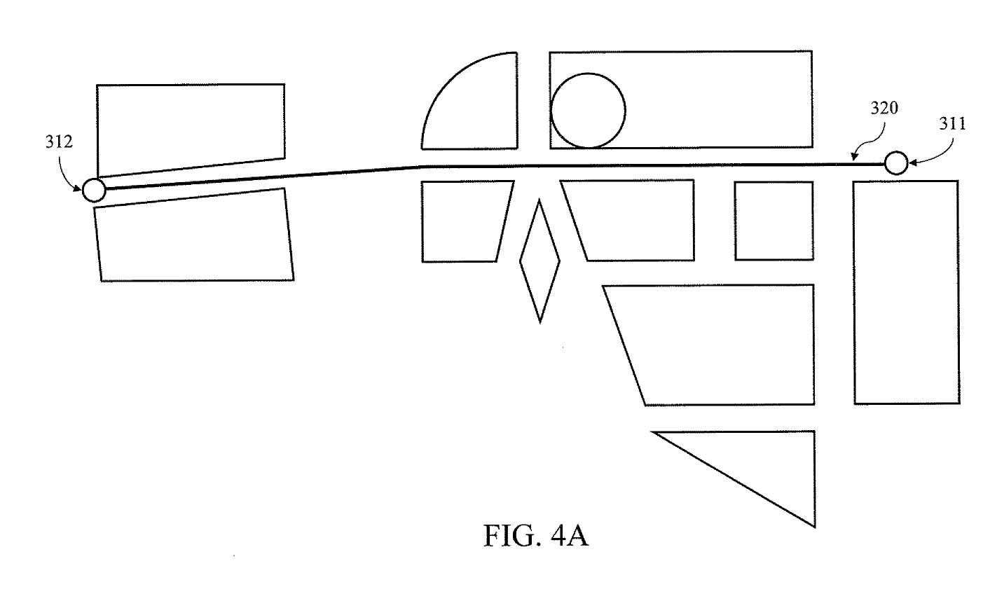

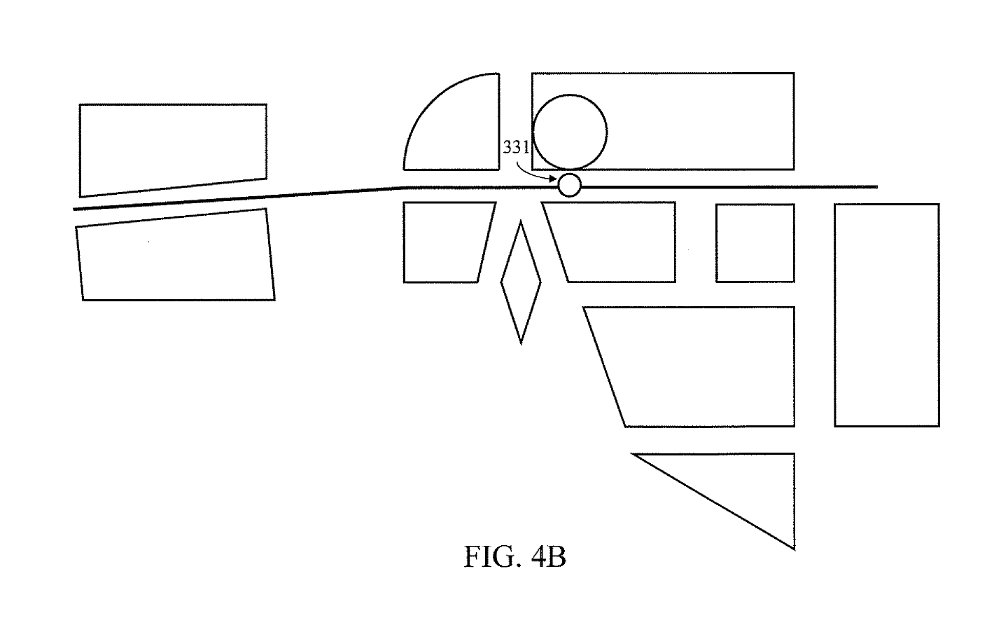

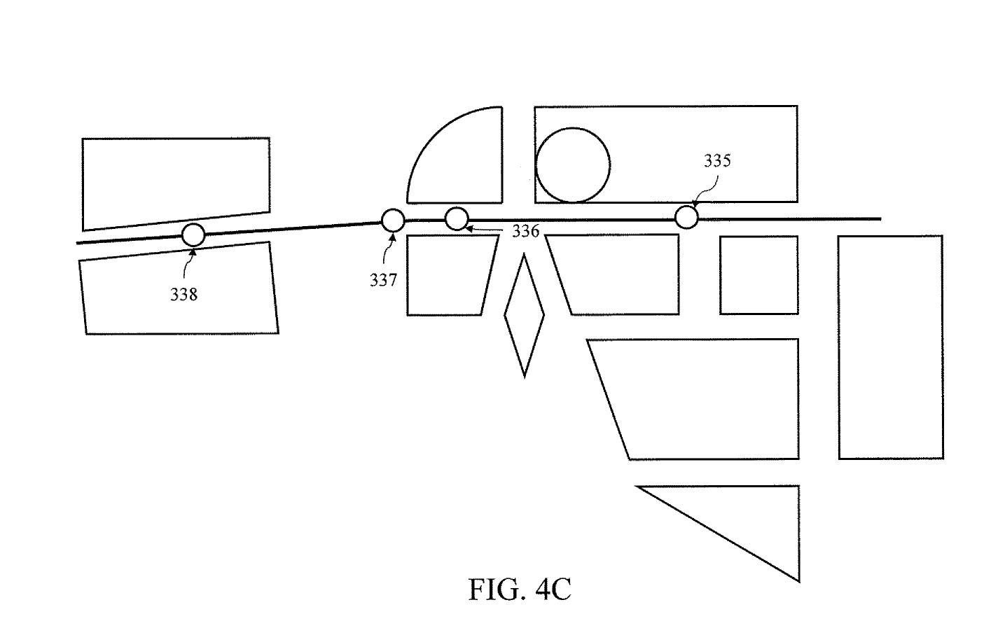

First, a parameter setting module 110 of the navigation terminal 100 may be used for a user to set a path planning parameter (step 210). In this embodiment, as shown in FIG. 4A, it is assumed that, a user is currently located in a position 311, and the user wants to reach a position 312; therefore, the user may activate a map browsing program on the smart mobile phone (the navigation terminal 100), and set a starting position as the position 311 and a target position as the position 312 on the map browsing program through the parameter setting module 110.

After the parameter setting module 110 of the navigation terminal 100 sets the path planning parameter (step 210), a transmission module 130 of the navigation terminal 100 may transfer, through a network 400, the path planning parameter set by the parameter setting module 110 to a server 410 (step 219). In this embodiment, the path planning parameter transferred by the transmission module 130 is the starting position and the target position.

After receiving the path planning parameter transferred by the transmission module 130, the server 410 may plan a moving path according to the path planning parameter (step 220a). In this embodiment, the server 410 may plan the moving path according to the starting position and the target position, and it is assumed that the moving path 320 planned by the server 410 is shown in FIG. 4A.

After the server 410 plans the moving path according to the path planning parameter (step 220a), the server 410 may search for a target location surrounding the planned moving path from a database, and read a location message corresponding to the found target location (step 230). In this embodiment, it is assumed that the server 410 may search for a target location of which a shortest distance is within a preset value on the moving path, for example, scenic spots “the Oriental Pearl Tower” and “the Bund”, in this way, the server 410 may read location messages corresponding to the scenic spots “the Oriental Pearl Tower” and “the Bund”, and the location message found by the server 410 includes position information corresponding to the target location, such as, longitude and latitude.

After the server 410 finds, according to the moving path, the location message corresponding to the target location (step 230), the server 410 may return the planned moving path and the found location message to the smart mobile phone (the navigation terminal 100) through a network 400.

After the transmission module 130 of the navigation terminal 100 receives the moving path and the location message transferred, through the network 400, by the server 410, a display module 160 of the navigation terminal 100 may display the moving path received by the transmission module 130 (step 260).

Then, the display module 160 of the navigation terminal 100 may continually determine whether a driving distance and/or a relative position of a position where the navigation terminal 100 is currently located and the target location received by the transmission module 130 of the navigation terminal 100 satisfies a predetermined condition (step 270a). In this embodiment, it is assumed that the display module 160 may calculate a driving distance or a driving distance and an azimuth of the navigation terminal 100 and each target location according to a longitude and a latitude of a target location in each piece of location message and a longitude and a latitude of the position where the navigation terminal 100 is currently located, and at the same time, determine, with reference to a direction that the navigation terminal 100 moves on the moving path 320, whether the predetermined condition is satisfied.

When a driving distance and/or a relative position of a position where the navigation terminal 100 is currently located and a certain target location satisfies the predetermined condition, the display module 160 of the navigation terminal 100 may display a location message corresponding to the target location that satisfies the predetermined condition (step 280a). In this embodiment, if the predetermined condition is a target location of which a driving distance to the navigation terminal 100 is the shortest and that the navigation terminal 100 does not reach, it is indicated that before a user reaches a position 331 as shown in FIG. 4B, the scenic spot “the Oriental Pearl Tower” is more closer to the user than “the Bund”; therefore, the display module 160 determines that a target location that satisfies the predetermined condition is the scenic spot “the Oriental Pearl Tower”, and displays a location message of the scenic spot “the Oriental Pearl Tower”, for example, displays an introduction, relevant costs, and so on of “the Oriental Pearl Tower” on the smart mobile phone (the navigation terminal 100) through a pop-up window (pop-up window), which may even include an advertisement of a merchant around “the Oriental Pearl Tower”. Then, after the user reaches the position 331, because the user has reached the scenic spot “the Oriental Pearl Tower”, the display module 160 determines that a target location that satisfies the predetermined condition is the scenic spot “the Bund”; therefore, the display module 160 displays a location message of the scenic spot “the Bund” on the smart mobile phone through a new pop-up window.

The operating system and method of the present invention is continually illustrated through a second embodiment with reference to procedures in FIG. 3A and FIG. 3B. In this embodiment, it is assumed that a navigation terminal 100 is a navigation device.

First, a parameter setting module 110 of the navigation terminal 100 may be used for a user to set a path planning parameter (step 210). In this embodiment, it is assumed that the user sets a target position as a position 312 on the navigation device (the navigation terminal 100) through the parameter setting module 110, and at the same time, the parameter setting module 110 also sets a position (namely, a position 311) where a smart mobile phone is currently located, which is determined by a positioning module 120 of the navigation terminal 100, as a starting position.

After the parameter setting module 110 of the navigation terminal 100 sets the path planning parameter (step 210), a path planning module 190 that can be added in the navigation terminal 100 may plan a moving path 320 according to the path planning parameter set by the parameter setting module 110 (step 220b). Then, a transmission module 130 of the navigation terminal 100 may transfer the moving path 320 planned by the path planning module 190 in the navigation terminal 100 to a server 410 (step 229).

After receiving the moving path 320 transferred by the transmission module 130, the server 410 may search a database for a target location within a certain distance that surrounds planned moving path, read a location message corresponding to the found target location (step 230), and return the found location message to the smart mobile phone (the navigation terminal 100).

Similarly, after the path planning module 190 in the navigation terminal 100 plans the moving path 320 according to the path planning parameter set by the parameter setting module 110 (step 220b), a display module 160 of the navigation terminal 100 may display the moving path 320 planned by the path planning module 190 in an electronic map (step 260). In practice, the transmission module 130 of the navigation terminal 100 generally transfers the moving path 320 to the server 410 (step 229) and receives location message returned by the server 410 after the display module 160 displays the moving path 320 (step 260), which, however, is not particularly limited in the present invention.

After the transmission module 130 of the navigation terminal 100 receives the location message, the display module 160 of the navigation terminal 100 may continually determine whether a driving distance or a relative position of a position where the navigation terminal 100 is currently located and the target location received by the transmission module 130 of the navigation terminal 100 satisfies a predetermined condition (step 270a), and when a driving distance or a relative position of a position where the navigation terminal 100 is currently located and a certain target location satisfies the predetermined condition, the display module 160 may display a location message corresponding to the target location that satisfies the predetermined condition (step 280a).

In this embodiment, if the predetermined condition is a target location of which a driving distance to the location where the navigation terminal 100 is currently located is determined to be smaller than a preset value, it is assumed that the display module 160 calculates a driving distance between the navigation terminal 100 and each target location according to a longitude and a latitude of a target location in each piece of location message and a longitude and a latitude of the position where the navigation terminal 100 is currently located, and when the user moves between a position 335 and a position 336 as shown in FIG. 4C, the display module 160 calculates that a driving distance between a position where the navigation terminal 100 is located and a scenic spot “the Oriental Pearl Tower” is smaller than the preset value, it is indicated that the scenic spot “the Oriental Pearl Tower” satisfies the predetermined condition; therefore, the display module 160 of the navigation terminal 100 displays a location message of the scenic spot “the Oriental Pearl Tower” in the electronic map displayed by the navigation device (the navigation terminal 100), and when the user moves between a position 337 and a position 338, the display module 160 calculates that a target location that satisfies the predetermined condition is a scenic spot “the Bund”; therefore, the display module 160 displays a location message of the scenic spot “the Bund” in the electronic map displayed in the navigation device.

In the foregoing embodiment, if the scenic spots “the Oriental Pearl Tower” and “the Bund” both satisfy the predetermined condition, when the user moves between the position 335 and the position 336, the display module 160 may also increase a display frequency and display time of a location message of a target location closer to the navigation terminal 100, or lower a display frequency and display time of a location message of a target location farther away from the navigation terminal 100, so that the display module 160 alternatively displays location messages of the scenic spots “the Oriental Pearl Tower” and the scenic spot “the Bund”, where the number of times for displaying the location message of the scenic spot “the Oriental Pearl Tower” and the time when the message is displayed each time is greater than the number of times for displaying the location message of the scenic spot “the Bund” and the time when the message is displayed each time.

The operating system and method of the present invention is illustrated through a third embodiment below with reference to procedures in FIG. 3A and FIG. 3C. In this embodiment, it is assumed that a navigation terminal 100 is a tablet PC.

First, a parameter setting module 110 of the navigation terminal 100 may be used for a user to set a path planning parameter (step 210). In this embodiment, it is assumed that the user may input addresses or reference targets of a position 311 and a position 312 on the tablet PC (the navigation terminal 100) through the parameter setting module 110, so as to set the position 311 as a starting position and the position 312 as a target position.

After the parameter setting module 110 of the navigation terminal 100 sets the path planning parameter (step 210), a transmission module 130 of the navigation terminal 100 may transfer the path planning parameter set by the parameter setting module 110 to a server 410 (step 219). After receiving the path planning parameter transferred by the transmission module 130, the server 410 may plan a moving path according to the path planning parameter (step 220a), search a database for a target location within a certain distance that surrounds the planned moving path, and read a location message corresponding to the found target location (step 230). In this embodiment, it is assumed that the location message found by the server 410 is location messages corresponding to scenic spots “the Oriental Pearl Tower” and “the Bund”.

After the server 410 finds, according to the moving path, the location message corresponding to the target location (step 230), the server 410 may determine preset time or a preset position of the found location message according to the path planning parameter (step 250). In this embodiment, the server 410 may predict, according to a walking speed of the user, the time of the user moving to the target location corresponding to the location message from the starting position or moving to the surrounding of the target location (the predicted time is the preset time mentioned in the present invention), and write the predicted time into the location message. Additionally, the server 410 may also determine a position of the user moving to the surrounding of the target location on the moving path 320 (the determined position is the preset position mentioned in the present invention), and write the determined position into the location message.

After the server 410 determines the preset time or the preset position of the found location message according to the path planning parameter (step 250), the server 410 may return the planned moving path and the location message in which the preset time or the preset position is added to the tablet PC (the navigation terminal 100).

After the transmission module 130 of the navigation terminal 100 receives the moving path and location message that are transferred by the server 410, a display module 160 of the navigation terminal 100 may display the moving path 320 on an electronic map (step 260).

Then, if the location message received by the transmission module 130 of the navigation terminal 100 includes the preset time, the display module 160 of the navigation terminal 100 may determine whether the preset time of the location message satisfies a predetermined condition after the transmission module 130 receives the location message (step 270b). In this embodiment, if the predetermined condition is the time calculated by the display module 160 meets the preset time included in the location message. When the display module 160 starts calculating the time after the transmission module 130 receives the location message, and determines whether the calculated time meets the preset time included in the location message, and when the time calculated by the display module 160 meets the preset time included in the location message, the location message including the met preset time may be displayed (step 280b).

If the location message received by the transmission module 130 of the navigation terminal 100 includes the preset position, the display module 160 of the navigation terminal 100 may determine whether the preset position of a location message satisfies a predetermined condition after the transmission module 130 receives the location message (step 270b). In this embodiment, the display module 160 continually determines whether a position where the navigation terminal 100 is currently located, which is determined by a positioning module 120 of the navigation terminal 100, meets the preset position included in the location message, and when the position where the navigation terminal 100 is currently located meets the preset location (the predetermined condition), the location message including the met preset location is displayed (step 280b).

In this way, it can be known from the foregoing three embodiments that, in a situation that the user moves along the moving path, in the present invention, when the user is close to a scenic spot (a target location), location message of the scenic spot that is close to is provided for the user, so that the user may obtain information such as introduction of the scenic spot that is close to.

In the foregoing three embodiments, if the navigation terminal 100 includes the positioning module 120 and a target prompt module 170 that can be added, the positioning module 120 may determine, through a positioning system, the position where the navigation terminal 100 is currently located, and the target prompt module 170 of the navigation terminal 100 may output a prompt message corresponding to the target location when determining that a driving distance between the position where the navigation terminal 100 is currently located and the target location is smaller than the preset value (step 290). In this embodiment, it is assumed that the target prompt module 170 calculates the driving distance between the position where the navigation terminal 100 is currently located and the target location according to the position where the navigation terminal 100 is currently located, which is determined by the positioning module 120, and a position of the target location, and generates a prompt message including a text and a control signal when the calculated driving distance is smaller than the preset value, where the text part in the prompt message is displayed on the navigation terminal 100, so as to notify the user of reaching the surrounding of the target location, and the control signal in the prompt message controls the navigation terminal 100 to make a sound and/or vibrate, so that the user may know reaching of the surrounding of the target location by viewing the text currently existing on the navigation terminal 100 after the navigation terminal 100 makes a sound and/or vibrates.

To sum up, it can be known that, the difference between the present invention and the prior art lies in having the technical means of the server searching, according to the planned moving path, for the location message corresponding to the target location, and the navigation terminal displaying the satisfied or met location message when determining that the driving distance or the relative position of the position where the navigation terminal is currently located and the target location satisfies the predetermined condition or determining that the preset time or the preset position is met, so as to solve, by using the technical means, the problem that an electronic map fails to give a prompt to a user when close to a target location existing in the prior art, thereby achieving the technical efficacy of proactively providing location message for the user.

Furthermore, the navigation message providing method of in the present invention can be implemented in hardware, software, or a combination of hardware and software, and can also be implemented in a computer system in a centralized manner or implemented in a decentralized manner that different elements are distributed in several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A navigation message providing method, at least comprising:
a navigation terminal setting a path planning parameter, wherein the path planning parameter at least comprises a starting position and at least one target location;
the navigation terminal transferring the path planning parameter to a server;
the server planning a moving path according to the path planning parameter;
the server searching for at least one location message corresponding to each target location according to the moving path;
the navigation terminal displaying the moving path; and
the navigation terminal displaying a location message corresponding to a target location that satisfies the predetermined condition when determining that a driving distance or a relative position of a position where the navigation terminal is currently located and each target location satisfies a predetermined condition.

2. The navigation message providing method according to claim 1, wherein the step of the navigation terminal setting the path planning parameter is: the navigation terminal setting the path planning parameter through a voice operation and/or a touch operation.

3. The method for providing navigation message according to claim 1, wherein the step of displaying the location message corresponding to the target location that satisfies the predetermined condition further comprises a step of the navigation terminal adjusting display time and a display frequency of each location message according to a distance between the position where the navigation terminal is currently located and each target location on the moving path.

4. A navigation message providing method, at least comprising the following steps:
a navigation terminal setting a path planning parameter, wherein the path planning parameter at least comprises a starting position and at least one target location;
the navigation terminal transferring the path planning parameter to a server;
the server planning a moving path according to the path planning parameter;
the server searching for at least one location message corresponding to at least one target location according to the moving path;
the server determining preset time or a preset position of each location message according to the path planning parameter;
the navigation terminal displaying the moving path;
the navigation terminal determining whether the preset time or the preset position of each location message satisfies a predetermined condition; and
the navigation terminal displaying the location message satisfied the predetermined condition.

5. The navigation message providing method according to claim 4, wherein the step of the navigation terminal displaying the location message satisfied the predetermined condition further comprises a step of the navigation terminal adjusting display time and a display frequency of each location message according to a time difference between current time and preset time of each location message, or according to a distance between a position where the navigation terminal is currently located and a preset position of each location message.

6. A navigation message providing system, applied to a navigation terminal, at least comprising:
a parameter setting module, used for setting a path planning parameter, wherein the path planning parameter at least comprises a starting position and at least one target location, and is used for planning and generating a moving path;
a transmission module, used for receiving at least one location message corresponding to at least one target location, wherein the location message is found according to the moving path; and
a display module, used for displaying the moving path, and used for displaying a met location message when preset time or a preset position in each location message satisfies a predetermined condition, or displaying a location message corresponding to a target location when a distance or a relative position of a position where the navigation terminal is currently located and the target location satisfies the predetermined condition.

7. The navigation message providing system according to claim 6, further comprising a positioning module, used for continually obtaining position information, so as to determine a position where the navigation terminal is currently located.

8. The navigation message providing system according to claim 7, further comprising a target prompt module, used for outputting a prompt message corresponding to a target location when determining that a distance between the position where the navigation terminal is currently located and the target location on the moving path is smaller than a preset value.

9. The navigation message providing system according to claim 7, wherein the display module is further used for adjusting display time and a display frequency of each location message according to a distance between the position where the navigation terminal is currently located and each target location on the moving path, according to a time difference between current time and preset time of each location message, or according to a distance between the position where the navigation terminal is currently located and a preset position of each location message.

10. The navigation message providing system according to claim 6, further comprising a path planning module, used for generating the moving path according to the path planning parameter, wherein the transmission module is further used for transferring the moving path to the server, and receiving at least one location message corresponding to each target location when the sever finds each target location according to the moving path and returned the location messages back.
